(19) United States
(12) Patent Application Publication
(10) Pub. No.: US 2025/0003571 A1
(43) Pub. Date: Jan. 2, 2025

(54) Lamp Shade Cover and Table Lamp Combination

(71) Applicant: Suzanne Duin, Houston, TX (US)

(72) Inventor: Suzanne Duin, Houston, TX (US)

(21) Appl. No.: 18/799,781

(22) Filed: Aug. 9, 2024

Related U.S. Application Data
(63) Continuation-in-part of application No. 29/869,043, filed on Dec. 20, 2022.
(63) Continuation-in-part of application No. 29/916,266, filed on Nov. 9, 2023.

(51) Int. Cl. F21V 1/14

(52) U.S. Cl. CPC F21V 1/14

(57) ABSTRACT

A lamp with a lamp shade cover is disclosed. The lamp has upper portion that houses the lights and has a tapered sidewall. The lamp shade cover has a tapered sidewall that corresponds with the tapered sidewall of the lamp such that the lamp shade cover is press-fit onto the upper portion without use of fitter hardware.

### CROSS-REFERENCE TO RELATED APPLICATIONS

The present application is a Continuation-in-Part of U.S. Design patent application Ser. No. 29/869,043 (pending), filed on Dec. 20, 2022, the entirety of which is incorporated herein by reference. The present application is also a Continuation-in-Part of U.S. Design patent application Ser. No. 29/916,266 (pending), filed on Nov. 9, 2023, the entirety of which is incorporated herein by reference.

### FIELD

The present disclosure relates to lamp shade covers and table lamp combinations.

### BACKGROUND

Lamp shades are used to partially shield the light emitted from a lamp. Lamp shades are typically used for directing the light emitted from a lamp to illuminate the surrounding environment, while shielding a direct view of the lightbulb of the lamp to avoid undesirable light effects, such as glare. Lamp shades are typically attached to a lamp using a spider fitting.

Some lamps are designed to be used without a lamp shade and, thus, lack any hardware for connecting with a lamp shade. However, such lamps typically have a harsh appearance and may still emit an undesirable amount of light and/or cause glare.

### BRIEF SUMMARY

Embodiments of the present disclosure include an assembly of a lamp with a lamp shade cover. The assembly includes a table lamp and a lamp shade cover situated about the table lamp. The lamp shade cover lacks a lamp shade spider fitter or other fitter structure connecting the lamp shade cover and the table lamp.

Embodiments of the present disclosure include a lamp shade cover that lacks a lamp shade spider fitter or other fitter structure.

Embodiments of the present disclosure include an assembly of a lamp with a lamp shade cover. The assembly includes a lamp having a base and an upper portion. The upper portion has a top end, a bottom end, and a sidewall extending between the top and bottom ends. The sidewall is tapered from the top end to the bottom end such that a width of the upper portion at the top end is less than a width of the upper portion at the bottom end. The assembly includes a lamp shade cover having a shade body with a top end, a bottom end, and a sidewall extending between the top and bottom ends. The sidewall of the lamp shade body is tapered from the top end to the bottom end such that a width of the shade body at the top end is less than a width of the shade body at the bottom end. The shade body has a hollow interior (e.g., void space) between the top and bottom ends thereof, a first opening at the top end into the hollow interior, and a second opening at the bottom end of the hollow interior. The hollow interior is surrounded by the inside surface of the sidewall of the shade body between the top and bottom ends thereof. The taper of the sidewall of the lamp shade cover corresponds with the taper of the sidewall of the upper portion of the lamp such that the lamp shade cover is press-fit onto the upper portion and such that the upper portion is positioned within the hollow interior.

Embodiments of the present disclosure include a method of attaching a lamp shade cover to a lamp. The method includes positioning a lamp shade cover about a table lamp. The lamp shade cover lacks a lamp shade spider fitter or other fitter structure connecting the lamp shade cover and the table lamp.

Embodiments of the present disclosure include a method of attaching a lamp shade cover to a lamp. The lamp has a base and an upper portion, The upper portion has a top end, a bottom end, and a sidewall extending between the top and bottom ends. The sidewall is tapered from the top end to the bottom end such that a width of the upper portion at the top end is less than a width of the upper portion at the bottom end. The method includes sliding a lamp shade cover over the upper portion of the lamp until the lamp shade cover is press-fit onto the upper portion of the lamp and the upper portion is at least partially positioned within a hollow interior of the lamp shade cover.

### BRIEF DESCRIPTION OF THE DRAWINGS

So that the manner in which the features and advantages of the assemblies, systems, and methods of the present disclosure may be understood in more detail, a more particular description briefly summarized above may be had by reference to the embodiments thereof which are illustrated in the appended drawings that form a part of this specification. It is to be noted, however, that the drawings illustrate only various exemplary embodiments and are therefore not to be considered limiting of the disclosed concepts as it may include other effective embodiments as well.

FIG. 1 is a side elevation view of a lamp shade cover and table lamp combination, according to some embodiments.

FIG. 2 is a top view of the lamp shade cover and table lamp combination of FIG. 1.

FIG. 3 is a bottom view of the lamp shade cover and table lamp combination of FIG. 1.

FIG. 4 is a perspective view of the lamp shade cover and table lamp combination of FIG. 1.

FIG. 5 is an enlarged perspective view of the lamp shade cover and table lamp combination of FIG. 1.

FIG. 6 is a cross-sectional view along line 6-6 of FIG. 1.

FIG. 7 is a top view of the lamp shade cover without the table lamp.

FIG. 8 is a bottom view of the lamp shade cover without the table lamp.

FIG. 9 is a perspective view of the table lamp without the lamp shade cover.

### DETAILED DESCRIPTION

Embodiments of the present disclosure include a lamp shade cover. In some embodiments, the lamp shade cover is coupled with a lamp to form a table lamp combination.

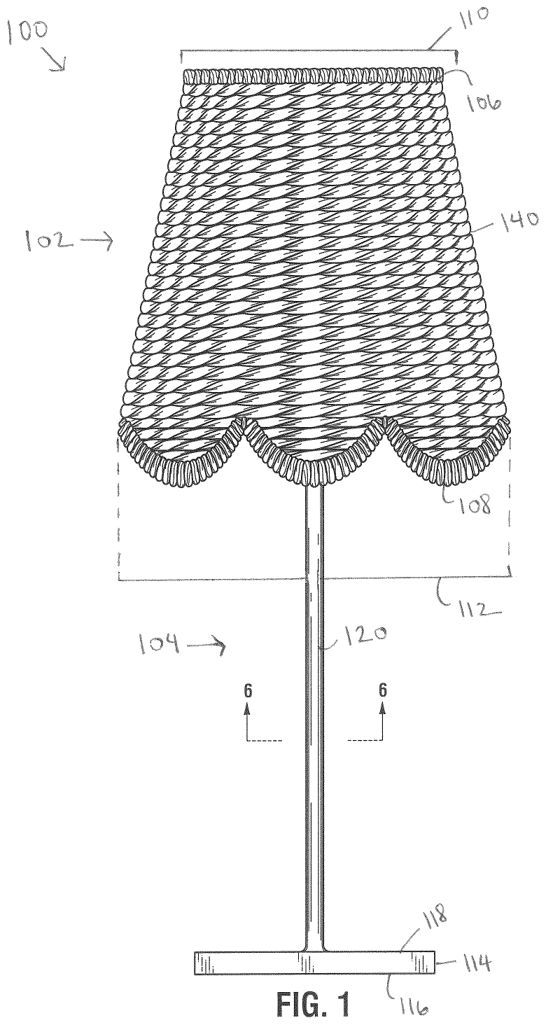

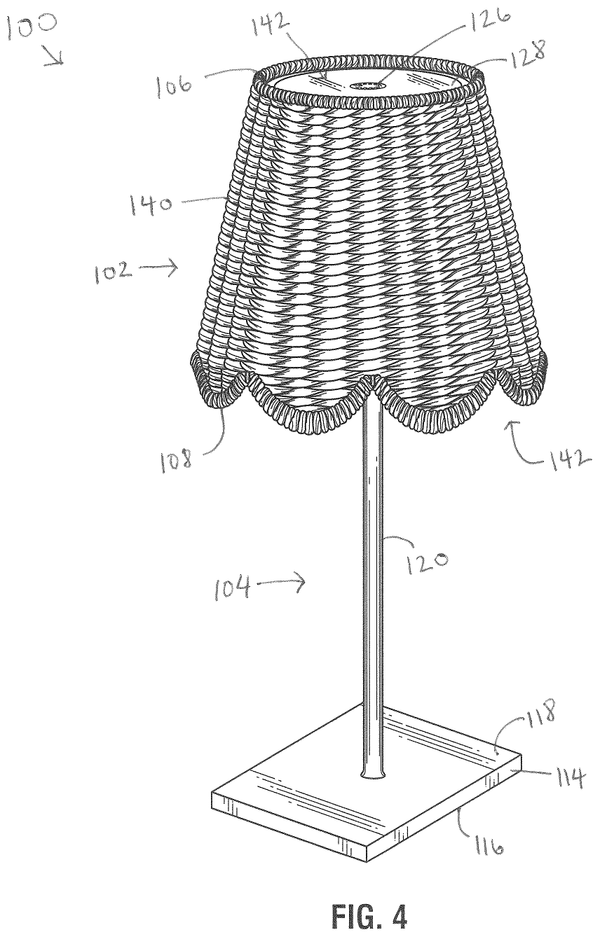

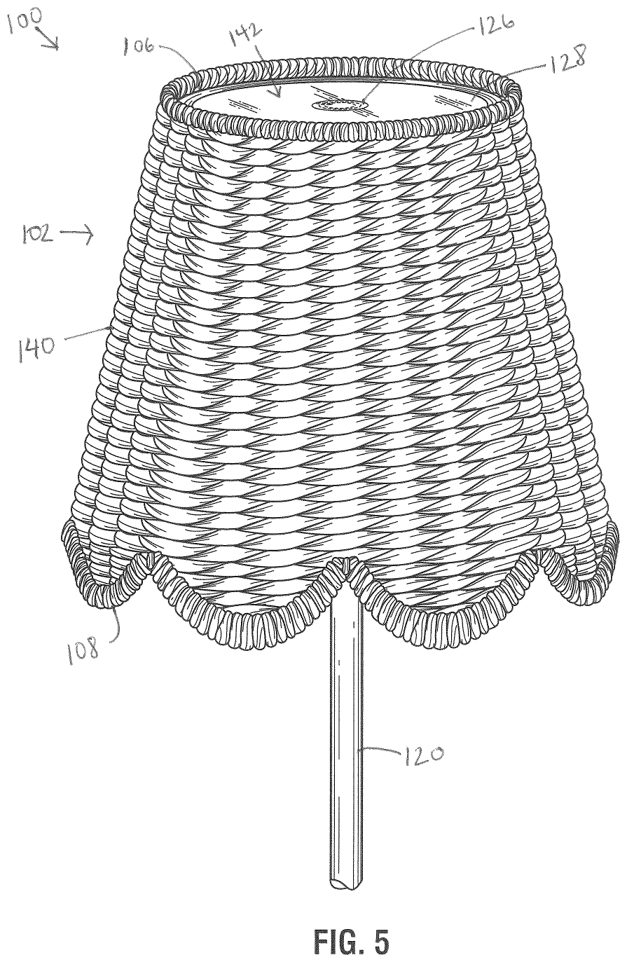

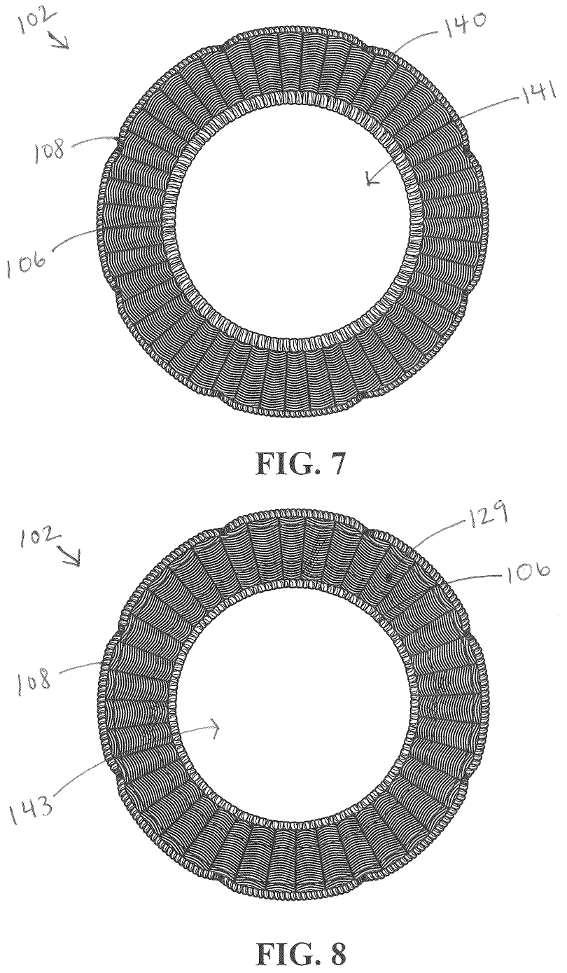

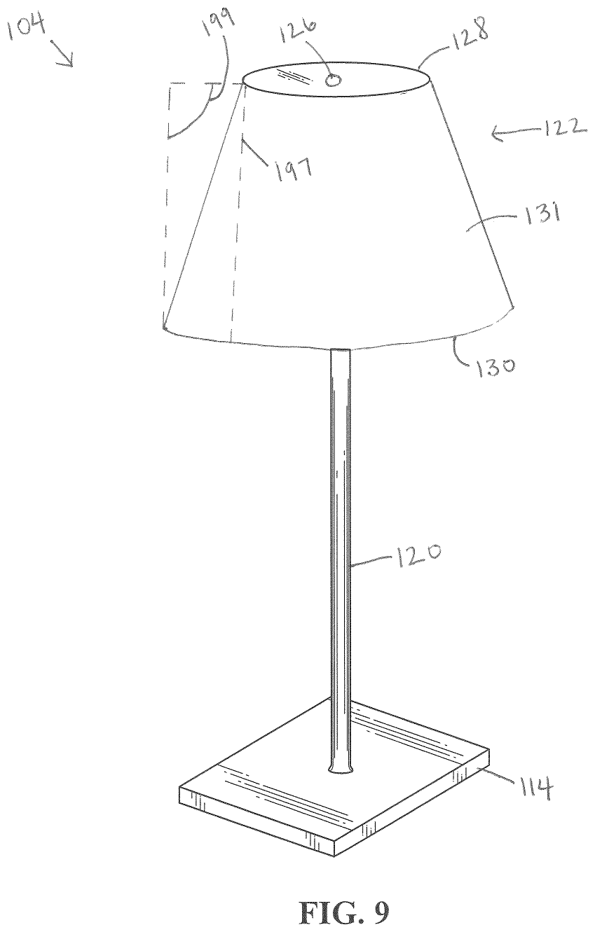

With reference to FIGS. 1-9, embodiments of the lamp shade cover and table lamp combination, or portions thereof, are depicted. Lamp shade cover and table lamp combination 100 includes lamp shade cover 102 and table lamp 104. While the lamp shade cover disclosed herein is shown and described as being attached with a table lamp, the lamp shade cover is not limited to this application and may be used with other types of lamps.

### Table Lamp

Table lamp 104 includes base 114. Base 114 includes a bottom surface 116 for engagement with another surface (e.g., the surface of a table). Base 114 includes a top surface 118. Table lamp 104 includes a stem 120 extending from the top surface 118. Table lamp 104 includes an upper portion 122. The upper portion 122 has a top end 128, a bottom end 130, and a sidewall 131 extending therebetween. Sidewall 131 may be or form a solid surface. The upper portion 122 includes lights 124 at the bottom end 130 and a power button 126 at the top end 128 for turning on and off the lights 124. In some embodiments, the upper portion 122 is a housing that houses at least some of the electronic components of the table lamp 104 (e.g., the lights 124, power button 126, and other associated electronic components and/or wiring). In some embodiments, the upper portion 122 generally has the shape of a lamp shade, but without functioning as a lampshade.

From the top end 128 to the bottom end 130, the sidewall 131 is tapered at angle 199 such that the top end 128 has a first width 132, the bottom end 130 has a second width 134, and the first width 132 is less than the second width 134. In some embodiments, moving from the top end 128 to the bottom end 130, the width of the upper portion 122 continuously increases.

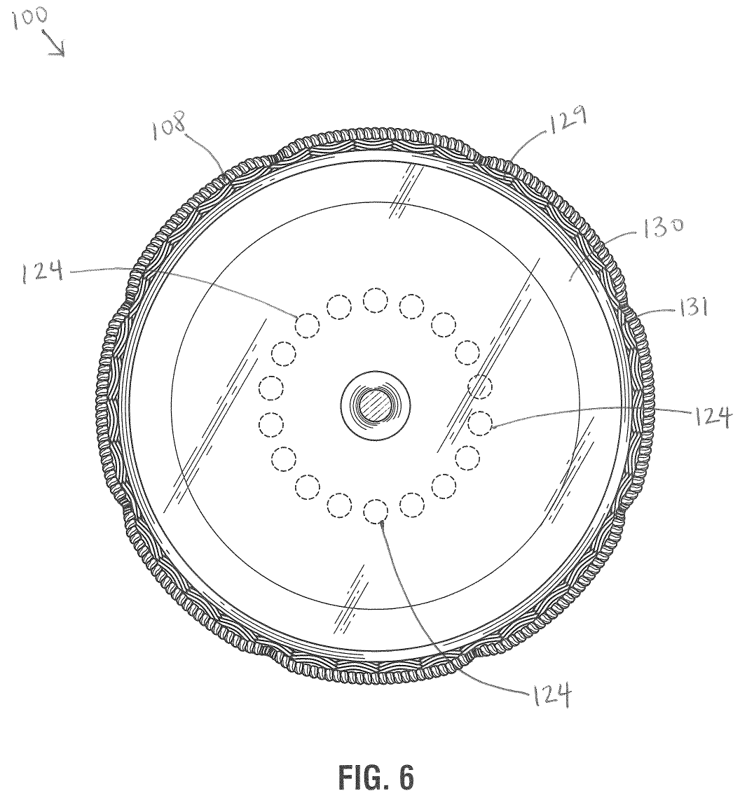

In some embodiments, the table lamp 104 lacks any hardware for connecting with a lamp shade, such as hardware for connecting with a spider fitting of a lamp shade. In some embodiments, the lights 124 of the lamp 104 are not viewable from the side view, such as in FIG. 1, and are only viewable from a bottom or at least partially bottom view, such as in FIG. 6.

### Lamp Shade Cover

Lamp shade cover 102 is positioned about the upper portion 122 of the table lamp 104. The lamp shade cover 102 has shade body 140 having a top end 106, a bottom end 108, and a sidewall 129 extending between the top end 106 and bottom end 108. The shade body 140 defines an annulus or hollow interior 142. The shade body 140 includes a first opening 141 into the hollow interior 142 at the top end 106 and a second opening 143 into the hollow interior 142 at the bottom end 108. When the lamp shade cover 102 is positioned about the upper portion 122, the upper portion 122 is at least partially, in some embodiments entirely, positioned within the hollow interior 142 and surrounded by the inner sidewall 129 of the shade body 140.

From the top end 106 to the bottom end 108, the sidewall 129 of the lamp shade cover 102 is tapered such that the top end 106 has a first width 110, the bottom end 108 has a second width 112, and the first width 110 is less than the second width 112. In some embodiments, moving from the top end 106 to the bottom end 108, the width of the lamp shade cover 102 continuously increases. The sidewall 131 of the upper portion 122 may be tapered at a first angle (e.g., angle 199), the sidewall 129 of the shade body 140 may be tapered at a second angle, and the first and second angles may be same or substantially the same. Tapering the sidewall 129 to correspond with (i.e., be tapered at the same angle 199 as) the tapering of the sidewall 131 provides the hollow interior 142 with a shape that corresponds with the shape of the upper portion 122 such that the lamp shade cover 102 fits onto the upper portion 122 and such that the upper portion 122 holds the lamp shade cover 102 in position on the table lamp 104. The tapering of the lamp shade cover 102 from the top end 106 to the bottom end 108 provides the lamp shade cover 102 with the capability of being press-fit (e.g., mated with) onto the upper portion 122 of the table lamp 104. The angle 199 can be measured relative to an imaginary line 197 that would extend between the edge first end 128 and an imaginary edge of the second end 130 if the second end 130 were of the same width as the first end 128.

While the sidewall 129 of the shade body 140 and the sidewall 131 of the upper portion 122 are described as being tapered at the same or similar angles, the apparatus disclosed herein is not limited to this particular arrangement. Other shapes of the shade body and upper portion may be used that are configured such that when the lamp shade cover is slid over the upper portion the upper portion and lamp shade cover contact one another and the contact with the upper portion holds the lamp shade cover in place in a position relative to the lamp.

In some embodiments, when the lamp shade cover 102 is positioned onto the upper portion 122, the sidewall 129 is in contact with the sidewall 131. In some embodiments, when the lamp shade cover 102 is positioned onto the upper portion 122, the sidewall 129 is contiguous with the sidewall 131. To attach the lamp shade cover 102 onto the table lamp 104, the bottom end 108 can be slid over the top end 128, and the lamp shade cover 102 can continue to be slid over the upper portion 122 until the upper portion 122 is at least partially, or entirely, positioned within the hollow interior 142. When the internal width of the hollow interior 142 matches, or substantially matches, the external width of the upper portion 122, the lamp shade cover 102 will be press-fit onto the upper portion 122.

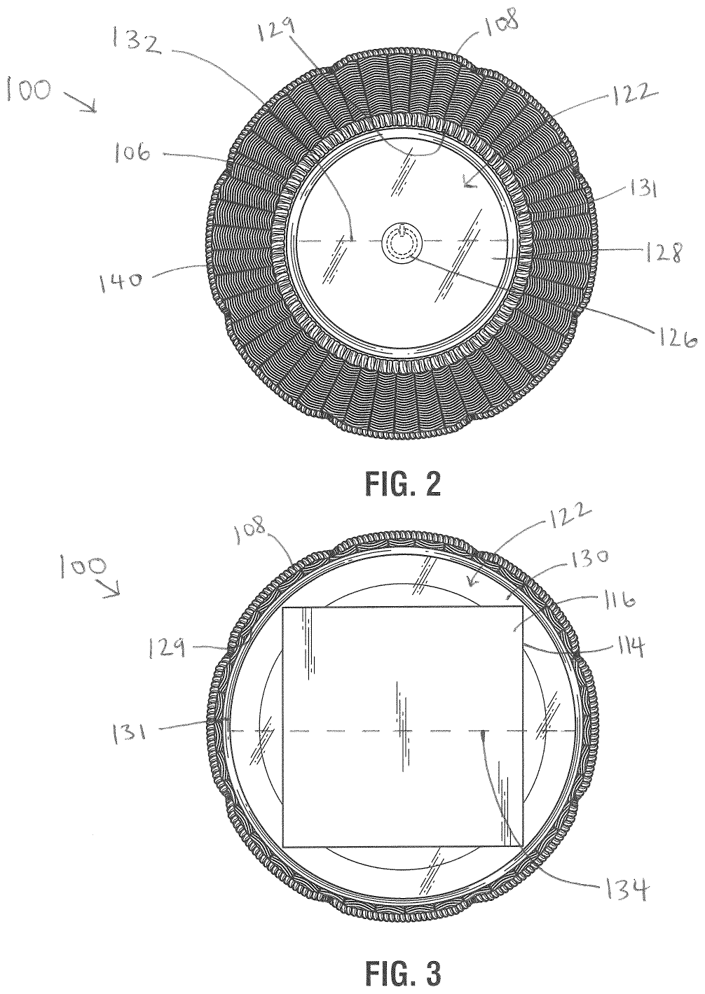

The lamp shade cover 102 lacks a spider fitting for attachment with the table lamp 104. In the embodiments depicted in FIGS. 1-9, the lamp shade cover 102 lacks any structure within the hollow interior 142 such that the hollow interior 142 is a void space when the upper portion 122 is not positioned therein. In some such embodiments, the lamp shade cover 102 is only attached with the table lamp 104 via press fitting the lamp shade cover 102 over the upper portion 122. Thus, the lamp shade cover 102 is attached with the table lamp 104 without use of a lamp shade spider fitting and without use of any fitting structure other than the corresponding shapes of the lamp shade cover 102 and the upper portion 122. Without a spider fitting or other fitting structure, the top surface 128 of the table lamp 104 is presented and viewable from directly above the table lamp and lamp shade combination 100 without obstruction, as shown in FIGS. 2, 4, and 5.

In some embodiments, the shade body 140 is made of a weaved material, such as a weaved grass or other natural material. Examples of weaved material include weaved seagrass and weaved water hyacinth. In some embodiments, the shade body 140 is made of a twisted paper that is weaved together. In other embodiments, the shade body 140 is made of paper that is not weaved. The shade body 140 may be dyed or otherwise colorized to modify that color of the material.

With the lamp shade cover 102 positioned onto the upper portion 122 of the lamp 104, the lamp shade cover 102 blocks and/or filters at least some of the light emitted from the lamp 104, while also covering up the sidewall 131 of the lamp 104 and presenting, instead, the shade body 140 for view. Additionally, the first opening 141 allows for unobstructed access to the power button 126 of the lamp 104 and the second opening 143 allows the light to be emitted from the lights 124.

### Method

Some embodiments include a method of attaching a lamp shade cover to a lamp that has a base and an upper portion with a top end, bottom end, and a tapered sidewall extending therebetween such that a width of the upper portion at the top end is less than a width of the upper portion at the bottom end. The method includes sliding a lamp shade cover over the upper portion of the lamp until the lamp shade cover is press-fit onto the upper portion of the lamp and the upper portion is at least partially positioned within a hollow interior of the lamp shade cover. The sliding can include positioning the top end of the upper portion into and through a first opening into the hollow interior of the lamp shade cover at a bottom end of the lamp shade cover, and moving the top ends of the lamp and the lamp shade cover toward one another to engage an outer sidewall of the upper portion with an inner sidewall of the lamp shade body until the lamp shade cover is press-fit onto the upper portion. Some embodiments include providing the lamp shade cover with a shape and size configured to be press-fit with the upper portion of the lamp, such as tapering the sidewall of the lamp shade body to match (e.g., have the same angle as) the taper of the sidewall of the upper portion of the lamp. In some embodiments, the lamp shade cover is attached to the lamp without use of a spider fitting or any fitting other than the press-fit engagement between the lamp shade cover and the upper portion of the lamp.

Although the present embodiments and advantages have been described in detail, it should be understood that various changes, substitutions and alterations can be made herein without departing from the spirit and scope of the disclosure. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A lamp with a lamp shade cover, the lamp comprising:
a table lamp;
a lamp shade cover situated about the table lamp;
wherein the lamp shade cover lacks a lamp shade spider fitter for connecting the lamp shade cover and the table lamp.

2. A lamp shade cover, wherein the lamp shade cover lacks a lamp shade spider fitter.

3. A lamp with a lamp shade cover comprising:
a lamp, the lamp comprising a base and an upper portion, wherein the upper portion has a top end, a bottom end, and a sidewall extending between the top and bottom ends;
a lamp shade cover comprising a shade body having a top end, a bottom end, a sidewall extending between the top and bottom ends, a hollow interior between the top and bottom ends thereof, a first opening at the top end into the hollow interior, and a second opening at the bottom end into the hollow interior, and wherein the hollow interior is surrounded by the sidewall of the shade body; and
wherein the upper portion is positioned at least partially within the hollow interior, and wherein the upper portion is in contact with an inner surface of the sidewall of the lamp shade cover.

4. The lamp of claim 3, wherein the contact between the upper portion and the inner surface of the sidewall holds the lamp shade cover in position relative to the lamp.

5. The lamp of claim 3, wherein the lamp shade cover is press-fit onto the upper portion.

6. The lamp of claim 3, wherein the sidewall of the upper portion is tapered from the top end to the bottom end such that a width of the upper portion at the top end is less than a width of the upper portion at the bottom end;
wherein the sidewall of the lamp shade cover is tapered from the top end to the bottom end such that a width of the shade body at the top end is less than a width of the shade body at the bottom end; and
wherein the taper of the sidewall of the lamp shade cover corresponds with the taper of the sidewall of the upper portion of the lamp.

7. The lamp of claim 6, wherein the angle of the taper of the sidewall of the lamp shade body is the same as the angle of the taper of the sidewall of the upper portion of the lamp.

8. The lamp of claim 3, wherein the inner surface of the sidewall of the lamp shade cover is in contact with an exterior surface of the sidewall of the upper portion of the lamp.

9. The lamp of claim 3, wherein the lamp comprises a stem extending between the base and the upper portion.

10. The lamp of claim 3, wherein the upper portion of the lamp comprises a housing include lights.

11. The lamp of claim 10, wherein the housing includes a power button configured to turn the lights on and off.

12. The lamp of claim 11, wherein the lights are positioned at the bottom end of the upper portion, and wherein the power button is positioned at the top end of the upper portion.

13. The lamp of claim 3, wherein only a portion of the upper portion of the lamp is positioned within the hollow interior of the lamp shade cover.

14. The lamp of claim 3, wherein an entirety of the upper portion of the lamp is positioned within the hollow interior of the lamp shade cover.

15. The lamp of claim 3, wherein a shape of the hollow interior of the lamp shade cover corresponds with a shape of the upper portion of the lamp.

16. The lamp of claim 3, wherein the lamp shade cover is slidable onto and off of the upper portion of the lamp.

17. The lamp of claim 3, wherein the internal width of the bottom end of the hollow interior matches or substantially matches the external width of the bottom end of the upper portion of the lamp.

18. The lamp of claim 3, wherein the hollow interior is a void space surrounded by the inner surface of the sidewall of the lamp shade cover, and wherein the lamp shade cover lacks any structure within the void space.

19. The lamp of claim 3, wherein the lamp shade cover lacks a spider fitting for attachment of the lamp shade cover with the lamp.

20. The lamp of claim 3, wherein the only attachment between the lamp shade cover and the lamp is via contact between the inner surface of the sidewall of the lamp shade cover and the upper portion of the lamp.

21-30. (canceled)
